(19) United States
(12) Patent Application Publication
(10) Pub. No.: US 2010/0321466 A1
(43) Pub. Date: Dec. 23, 2010

(54) Handheld Wireless Digital Audio and Video Receiver

(76) Inventor: Kendyl A. Román, Sunnyvale, CA (US)

Correspondence Address: KENDYL A ROMAN, 730 BANTRY COURT, SUNNYVALE, CA, 94087, US

(21) Appl. No.: 12/868,748

(22) Filed: Aug. 26, 2010

Related U.S. Application Data
(63) Continuation-in-part of application No. 09/467,721, filed on Dec. 20, 1999, now Pat. No. 7,233,619.
(60) Provisional application No. 60/113,051, filed on Dec. 21, 1998.

(51) Int. Cl. H04N 7/14

(52) U.S. Cl. 348/14.02; 348/E07.077

(57) ABSTRACT

A handheld, wireless digital audio and/or video device that receives compressed media, decompresses the compressed media, and plays and/or displays the decompressed media. The receiver may be part of a system of handheld, wireless devices that compress, enhance, encode, transmit, decompress and display digital video images in real time. An enhanced iPod-type device includes wireless and/or cellular communications, a high-resolution display and a high-resolution video camera. Real time wireless videoconferences connect multiple handheld video devices. Real time compression and real time transmission is achieved. Real time decompression is achieved by decoding and decompressing the encoded data to display high quality images. A zoom control can be used select a portion of interest of video being captured and/or transmitted. The receiver may also have a touch sensitive display screen providing controls for video display and mobile telephone operation. In one embodiment, a handheld, wireless digital audio device is configured to receive compressed audio data from either a wireless satellite network or a wireless Internet data network.

### CROSS-REFERENCE TO RELATED APPLICATIONS

This application is a continuation in part of U.S. patent application Ser. No. 09/467,721, filed on Dec. 20, 1999, and entitled “VARIABLE GENERAL PURPOSE COMPRESSION FOR VIDEO IMAGES (ZLN)”, now U.S. Pat. No. 7,233,619, which is incorporated herein by reference.

Co-pending U.S. patent application Ser. No. 11/262,106, filed on Oct. 27, 2005, published Jun. 1, 2006, as U.S. patent application publication 2006/0114987, entitled “HANDHELD VIDEO TRANSMISSION AND DISPLAY,” is also a continuation in part of U.S. patent application Ser. No. 09/467,721, and is incorporated herein by reference.

application Ser. No. 09/467,721 claims priority of U.S. provisional application Ser. No. 60/113,051, filed on Dec. 21, 1998, and entitled “METHODS OF ZERO LOSS (ZL) COMPRESSION AND ENCODING OF GRAYSCALE IMAGES”, which is incorporated herein by reference.

U.S. patent application Ser. No. 09/312,922, filed on May 17, 1999, and entitled “SYSTEM FOR TRANSMITTING VIDEO IMAGES OVER A COMPUTER NETWORK TO A REMOTE RECEIVER,” now U.S. Pat. No. 7,257,158, is incorporated herein by reference.

U.S. patent application Ser. No. 09/433,978, now U.S. Pat. No. 6,803,931, filed on Nov. 4, 1999, and entitled GRAPHICAL USER INTERFACE INCLUDING ZOOM CONTROL REPRESENTING IMAGE AND MAGNIFICATION OF DISPLAYED IMAGE″, is also incorporated herein by reference. A divisional application of U.S. Pat. No. 6,803,931, is U.S. patent application Ser. No. 10/890,079, filed on Jul. 13, 2004, published on Dec. 9, 2004 as publication number 2004/0250216, and entitled GRAPHICAL USER INTERFACE INCLUDING ZOOM CONTROL REPRESENTING IMAGE AND MAGNIFICATION OF DISPLAYED IMAGE″, and is incorporated herein by reference.

U.S. patent application Ser. No. 09/470,566, now U.S. Pat. No. 7,016,417, filed on Dec. 22, 1999, and entitled GENERAL PURPOSE COMPRESSION FOR VIDEO IMAGES (RHN)”, describes a compression method known as the “RHN” method, and is incorporated herein by reference.

U.S. patent application Ser. No. 09/473,190, filed on Dec. 20, 1999, and entitled “ADDING DOPPLER ENHANCEMENT TO GRAYSCALE COMPRESSION (ZLD)” is incorporated herein by reference.

U.S. patent application Ser. No. 10/154,775, filed on May 24, 2002, published as US 2003/0005428, and entitled “GLOBAL MEDIA EXCHANGE” is incorporated herein by reference.

U.S. patent application Ser. No. 12/157,225, filed on Jun. 7, 2008, published as US 2008/0250458, and entitled “MEDIA EXCHANGE FOR HANDHELD WIRELESS RECEIVERS AND OTHER MEDIA USER DEVICES,” is incorporated herein by reference.

U.S. patent application Ser. No. 09/436,432, filed on Nov. 8, 1999, and entitled “SYSTEM FOR TRANSMITTING VIDEO IMAGES OVER A COMPUTER NETWORK TO A REMOTE RECEIVER,” now U.S. Pat. No. 7,191,462, is incorporated herein by reference.

### BACKGROUND

1. Field of the Invention

This invention relates to handheld devices for wireless video transmission or reception, including video capture, file transfer and live streaming, and display.

2. Description of Prior Art

In the last few years, there have been tremendous advances in the speed of computer processors and in the availability of bandwidth of worldwide computer networks such as the Internet. These advances have led to a point where businesses and households now commonly have both the computing power and network connectivity necessary to have point-to-point digital communications of audio, rich graphical images, and video. However the transmission of video signals with the full resolution and quality of television is still out of reach. In order to achieve an acceptable level of video quality, the video signal must be compressed significantly without losing either spatial or temporal quality.

A number of different approaches have been taken but each has resulted in less than acceptable results. These approaches and their disadvantages are disclosed by Mark Nelson in a book entitled The Data Compression Book, Second Edition, published by M&T Book in 1996. Mark Morrision also discusses the state of the art in a book entitled The Magic of Image Processing, published by Sams Publishing in 1993.

### Video Signals

Standard video signals are analog in nature. In the United States, television signals contain 525 scan lines of which 480 lines are visible on most televisions. The video signal represents a continuous stream of still images, also known as frames, which are fully scanned, transmitted and displayed at a rate of 30 frames per second. This frame rate is considered full motion. Satellite transponders are used to transmit television signals across wide distances, e.g. from the East Coast to the West Coast, and to Hawaii and Alaska.

A television screen has a 4:3 aspect ratio.

When an analog video signal is digitized each of the 480 lines is sampled 640 times, and each sample is represented by a number. Each sample point is called a picture element, or pixel. A two dimensional array is created that is 640 pixels wide and 480 pixels high. This 640×480 pixel array is a still graphical image that is considered to be full frame. The human eye can perceive 16.7 thousand colors. A pixel value comprised of 24 bits can represent each perceivable color. A graphical image made up of 24-bit pixels is considered to be full color. A single, second-long, full frame, full color video requires over 220 millions bits of data.

The transmission of 640×480 pixels×24 bits per pixel times 30 frames requires the transmission of 221,184,000 million bits per second. A T1 Internet connection can transfer up to 1.54 million bits per second. A high-speed (56 Kb) modem can transfer data at a maximum rate of 56 thousand bits per second. The transfer of full motion, full frame, full color digital video over a T1 Internet connection, or 56 Kb modem, will require an effective data compression of over 144:1, or 3949:1, respectively.

A video signal typically will contain some signal noise. In the case where the image is generated based on sampled data, such as an ultrasound machine, there is often noise and artificial spikes in the signal. A video signal recorded on magnetic tape may have fluctuations due the irregularities in the recording media. Florescent or improper lighting may cause a solid background to flicker or appear grainy. Such noise exists in the real world but may reduce the quality of the perceived image and lower the compression ratio that could be achieved by conventional methods.

### Basic Run-length Encoding

An early technique for data compression is run-length encoding where a repeated series of items are replaced with one sample item and a count for the number of times the sample repeats. Prior art shows run-length encoding of both individual bits and bytes. These simple approaches by themselves have failed to achieve the necessary compression ratios.

### Variable Length Encoding

In the late 1940s, Claude Shannon at Bell Labs and R. M. Fano at MIT pioneered the field of data compression. Their work resulted in a technique of using variable length codes where codes with low probabilities have more bits, and codes with higher probabilities have fewer bits. This approach requires multiple passes through the data to determine code probability and then to encode the data. This approach also has failed to achieve the necessary compression ratios.

D. A. Huffman disclosed a more efficient approach of variable length encoding known as Huffman coding in a paper entitled “A Method for Construction of Minimum Redundancy Codes,” published in 1952. This approach also has failed to achieve the necessary compression ratios.

### Arithmetic, Finite Context, and Adaptive Coding

In the 1980s, arithmetic, finite coding, and adaptive coding have provided a slight improvement over the earlier methods. These approaches require extensive computer processing and have failed to achieve the necessary compression ratios.

### Dictionary-Based Compression

Dictionary-based compression uses a completely different method to compress data. Variable length strings of symbols are encoded as single tokens. The tokens form an index to a dictionary. In 1977, Abraham Lempel and Jacob Ziv published a paper entitled, “A Universal Algorithm for Sequential Data Compression” in IEEE Transactions on Information Theory, which disclosed a compression technique commonly known as LZ77. The same authors published a 1978 sequel entitled, “Compression of Individual Sequences via Variable-Rate Coding,” which disclosed a compression technique commonly known as LZ78 (see U.S. Pat. No. 4,464,650). Terry Welch published an article entitled, “A Technique for High-Performance Data Compression,” in the June 1984 issue of IEEE Computer, which disclosed an algorithm commonly known as LZW, which is the basis for the GIF algorithm (see U.S. Pat. Nos. 4,558,302, 4,814,746, and 4,876,541). In 1989, Stack Electronics implemented a LZ77 based method called QIC-122 (see U.S. Pat. No. 5,532,694, U.S. Pat. No. 5,506,580, and U.S. Pat. No. 5,463,390).

These lossless (method where no data is lost) compression methods can achieve up to 10:1 compression ratios on graphic images typical of a video image. While these dictionary-based algorithms are popular, these approaches require extensive computer processing and have failed to achieve the necessary compression ratios.

### JPEG and MPEG

Graphical images have an advantage over conventional computer data files: they can be slightly modified during the compression/decompression cycle without affecting the perceived quality on the part of the viewer. By allowing some loss of data, compression ratios of 25:1 have been achieved without major degradation of the perceived image. The Joint Photographic Experts Group (JPEG) has developed a standard for graphical image compression. The JPEG lossy (method where some data is lost) compression algorithm first divides the color image into three color planes and divides each plane into 8 by 8 blocks, and then the algorithm operates in three successive stages:
(a) A mathematical transformation known as Discrete Cosine Transform (DCT) takes a set of points from the spatial domain and transforms them into an identical representation in the frequency domain.
(b) A lossy quantization is performed using a quantization matrix to reduce the precision of the coefficients.
(c) The zero values are encoded in a zig-zag sequence (see Nelson, pp. 341-342).

JPEG can be scaled to perform higher compression ratio by allowing more loss in the quantization stage of the compression. However this loss results in certain blocks of the image being compressed such that areas of the image have a blocky appearance and the edges of the 8 by 8 blocks become apparent because they no longer match the colors of their adjacent blocks. Another disadvantage of JPEG is smearing. The true edges in an image get blurred due to the lossy compression method.

The Moving Pictures Expert Group (MPEG) uses a combination of JPEG based techniques combined with forward and reverse temporal differencing. MPEG compares adjacent frames and, for those blocks that are identical to those in a previous or subsequent frame, only a description of the previous or subsequent identical block is encoded. MPEG suffers from the same blocking and smearing problems as JPEG.

These approaches require extensive computer processing and have failed to achieve the necessary compression ratios without unacceptable loss of image quality and artificially induced distortion.

### QuickTime: CinePak, Sorensen, H.263

Apple Computer, Inc. released a component architecture for digital video compression and decompression, named QuickTime. Any number of methods can be encoded into a QuickTime compressor/decompressor (codec). Some popular codec are CinePak, Sorensen, and H.263. CinePak and Sorensen both require extensive computer processing to prepare a digital video sequence for playback in real time; neither can be used for live compression. H.263 compresses in real time but does so by sacrificing image quality resulting in severe blocking and smearing.

### Fractal and Wavelet Compression

Extremely high compression ratios are achievable with fractal and wavelet compression algorithms. These approaches require extensive computer processing and generally cannot be completed in real time.

### Sub-Sampling

Sub-sampling is the selection of a subset of data from a larger set of data. For example, when every other pixel of every other row of a video image is selected, the resulting image has half the width and half the height. This is image sub-sampling. Other types of sub-sampling include frame sub-sampling, area sub-sampling, and bit-wise sub-sampling.

### Image Stretching

If an image is to be enlarged but maintain the same number of pixels per inch, data must be filled in for the new pixels that are added. Various methods of stretching an image and filling in the new pixels to maintain image consistency are known in the art. Some methods known in the art are dithering (using adjacent colors that appear to be blended color), and error diffusion, “nearest neighbor”, bilinear and bicubic.

### Portable Hand Held Devices: Pen-based Computers and PDAs

In the early 1990s, a number of pen based computers were developed. These portable computers were characterized by a display screen that could be also used as an input device when touched or stroked with a pen or finger. For example in 1991, NCR developed a “notepad” computer, the NCR 3125. Early pen-based computers ran three operating systems: DOS, Microsoft's Windows for Pen Computing and Go Corp.'s PenPoint. In 1993, Apple developed the Newton MessagePad, an early personal digital assistant (PDA). Palm developed the Palm Pilot in 1996. Later, in 2002, Handspring released the Treo which runs the Palm OS and features a Qwerty keyboard. In 2000, the Sony Clie, used the Palm OS and could play audio files. Later versions included a built-in camera and could capture and play Apple QuickTime™ video. Compaq (now Hewlett Packard) developed the iPAQ in 2000. The iPAQ and other PocketPCs run a version of Windows CE. Some PocketPC and PDA have wireless communication capabilities.

In 2001, Apple released a music player, called the iPod, featuring a small, internal hard disk drive that could hold over 1000 songs and fit in your pocket. The original iPod has a display, a set of controls, and ports for connecting to a computer, such as a Macintosh or PC, via Firewire, and for connecting to headphones. However, the original iPod did not have a color display, a built-in camera, built-in speakers, built-in microphone, or wireless communications.

In January of 2004, Apple released the iPod mini. In October of 2004, Apple released iPod Photo with a low-resolution (220×176 pixel) color display. In January of 2005, Apple released the iPod shuffle with a flash drive to as media storage, instead of a hard disk drive.

Thus, by January 2005, an Apple iPod, or iPod-type device, was well known as a device that was less than about 4.5 inches tall, less than 2.5 inches wide, less than 1 inch thick, and weighed less than about six ounces; having a processor, a program memory for storing the programs that run on the processor, a media memory for storing the media (which could be either a hard drive or a flash drive), a user interface comprising buttons and/or a touch surface, and an optional display. However, at that time iPods still did not have a high-resolution (640×480 pixels or greater) color display, a built-in camera, built-in speakers, built-in microphone, or wireless communications. Also in January 2005, iPods did not support video playback, video capture or video conferencing.

### Portable Hand Held Devices: Cell Phone and Picture Phones

The first cellular telephones had simple LCD displays suitable for displaying only a limited amount of text. More recently, cell phones have been developed which have larger, higher resolution displays that are both grayscale and color. Some cell phones have been equipped with built-in cameras with the ability to save JPEG still photos to internal memory. In April 2002, Samsung introduced a cell phone with a built-in still photo camera and a color display. The Samsung SCH-X590 can store up to 100 photos in its memory and can transfer still photos wirelessly.

Cell phones can be used as wireless modems. Initially they had limited data bandwidth. Next, digital cell phones were developed. By early 2002, bandwidth was typically 60-70 Kbps. Higher bandwidth wireless networks are being developed.

### Hand Held Devices are Limited is Size and Weight

Hand held devices are limited in size and weight. Many users are only willing to use a handheld device that weights a few ounces and can fit inside a typical shirt pocket, or even worn on their waist or arm. These size and weight limitation prevent handheld devices from having the electronic circuitry, processors, and batteries found in laptops and other larger computers. These limitations have made it impossible to provide full frame, full motion video display or live transmission on handheld devices.

### PDAs, PocketPCs, and Picture Phones are Limited by Battery Life, Processor Speed, and Network Bandwidth

The existing, commercially available hand held devices have not been able to support live or streaming video for a number of reasons. Uncompressed full-motion, full frame video requires extremely high bandwidth that is not available to handheld portable devices. In order to reduce the bandwidth, lossy compression such as MPEG has been used to reduce the size of the video stream. While MPEG is effective in desktop computers with broadband connections to the Internet, decoding and displaying MPEG encoded video is very processor intensive. The processors of existing handheld devices are slower or less powerful than those used in desktop computers. If MPEG were used in a handheld device, the processor would quickly drains the battery of most handheld devices. Further, the higher bandwidth wireless communications interfaces would also place a large strain on the already strained batteries. Live video transmission and reception would be even more challenging. For this reason, handheld device have not been able to transmit or receive streaming, or especially, live video.

What is needed is an enhanced handheld device that is capable of receiving streaming and live video. Further, a handheld device that could capture and transmit live video would provide live coverage of events that would otherwise not be able to be seen. With handheld video devices that both transmit and receive live video, handheld wireless videoconferencing could become a reality.

### SUMMARY OF THE INVENTION

In accordance with the present invention a handheld device comprises a high resolution black and white or color display screen, speakers or headphones for hearing audio, controls for user input, a memory for storing compressed audio and/or video data, and a processor for running computer programs which decompress the compressed media data and play the video on the display screen, and/or the audio on speakers and/or headphones. Further, some embodiments include a microphone and video camera for inputting audio and video. A plurality of handheld video devices are connected to a network for exchanging video files, streaming video from a pre-recorded video file or live transmission from one device to one or more devices in remote locations. The network connections can be wired or wireless.

Some embodiments comprise an iPod-type device and a video camera adding video capture capability. One embodiment comprises a built-in video camera for capturing live video. Yet another embodiment comprises a built-in video camera, mounted on the front of the device, for capturing live video during a live video conference.

Yet another embodiment includes a zoom control that is graphically displayed on the display screen and receives input from either the touch screen or the controls of the handheld device.

In yet another embodiment, a user may use the zoom control to send remote control commands to a transmitting device to dynamically specify an area to be transmitted.

The user may use the zoom control to control the video camera. Alternatively, the user may use the zoom control to magnify video that is being played from a file or streamed over the wireless network.

### Objects and Advantages

Accordingly, beside the objects and advantages of the method described above, some additional objects and advantages of the present invention are:
(a) to provide a handheld device for capturing audio and video which can be transmitted to another handheld device.
(b) to provide a handheld device for displaying video that has been received from a video capture and transmission device.
(c) to provide a handheld wireless video conferencing system comprising handheld devices which act as both transmitters and receivers connected over a wireless data network.
(d) to provide an enhanced iPod-type device to capture, transmit, or receive video.
(e) to provide an enhanced iPod-type device to wirelessly receive digital audio.
(f) to provide an enhanced iPod-type device play digital audio which was received wirelessly.
(g) to provide a graphical zoom control on a hand held video display device whereby the user can remotely control the area of the video that is being transmitted in high resolution.
(h) to provide a graphical zoom control on a hand held video display device whereby the user can magnify a video being displayed.
(i) to provide a method of compressing and decompressing video signals so that the video information can be transported across a digital communications channel in real time.
(j) to provide a method of compressing and decompressing video signals such that compression can be accomplished with software on commercially available computers without the need for additional hardware for either compression or decompression.
(k) to provide a high quality video image without the blocking and smearing defects associated with prior art lossy methods.
(l) to provide a high quality video image that suitable for use in medical applications.
(m) to enhance images by filtering noise or recording artifacts.
(n) to provide a method of compression of video signals such that the compressed representation of the video signals is substantially reduced in size for storage on a storage medium.
(o) to provide a level of encryption so that images are not directly viewable from the data as contained in the transmission.

### DRAWING FIGURES

In the drawings, closely related figures have the same number but different alphabetic suffixes.

FIG. 1 shows the high level steps of compression and decompression of an image.

FIG. 2 shows an image and a corresponding stream of pixels.

FIGS. 3A and 3B show machines for compressing and decompressing, respectively.

FIG. 3C shows a compressor and decompressor connected to a storage medium.

FIG. 3D shows a compressor and decompressor connected to a communications channel.

FIG. 3E shows elements of a compressor.

FIGS. 4A through 4C show various network configuration comprising handheld video devices.

FIGS. 5A through 5D show various embodiments of handheld video devices.

FIGS. 6A through 6C show handheld video devices comprising graphical zoom controls.

FIGS. 7A through 7C show various embodiments of handheld wireless digital audio and/or video receivers.

### DESCRIPTION OF THE INVENTION

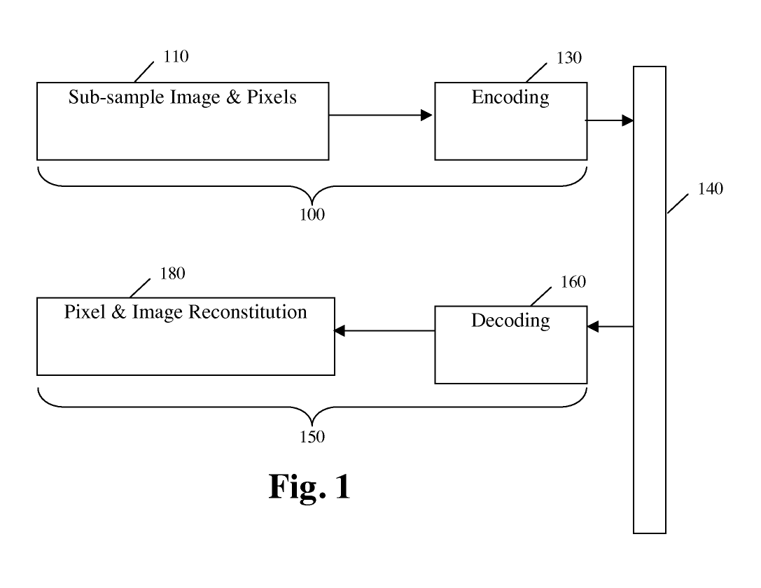

### FIG. 1

### Compression and Decompression Steps

FIG. 1 illustrates a sequence of compression steps 100 and a sequence of decompression steps 150 of the present invention. The compression steps 100 comprise a sub-sampling step 110 and an encoding step 130. After completion of the compression steps 100, a stream of encoded data 140 is output to either a storage medium or a transmission channel. The decompression steps 150 comprise a decoding step 160 wherein the stream of encoded data 140 is processed and an image reconstitution step 180.

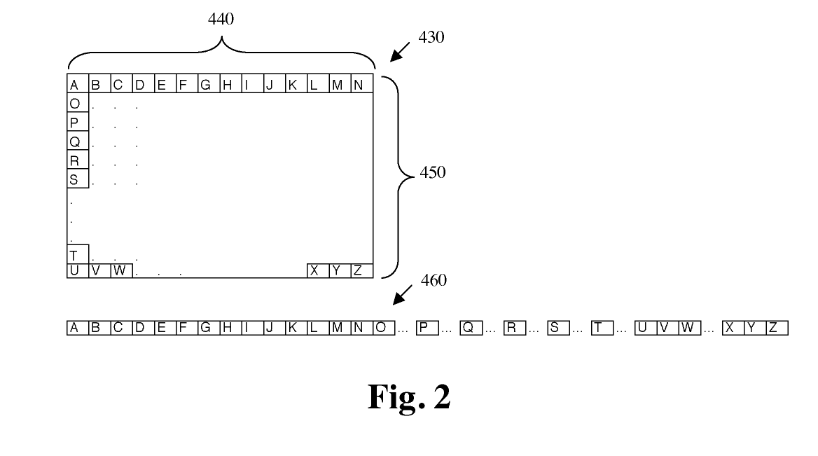

### FIG. 2

### Image and Pixel Stream

FIG. 2 illustrates an image and its corresponding stream of pixels. A rectangular image 430 is composed of rows and columns of pixels. The image 430 has a width 440 and a height 450, both measured in pixels. In this illustrative embodiment, pixels in a row are accessed from left to right. Rows are accessed from top to bottom. Some pixels in the image are labeled from A to Z. Pixel A is the first pixel and pixel Z is the last pixel. Scanning left to right and top to bottom will produce a pixel stream 460. In the pixel stream 460, pixels A and B are adjacent. Also pixels N and O are adjacent even though they appear on different rows in the image.

Because the video signal being digitized is analog there will be some loss of information in the analog to digital conversion. The video digitizing hardware can be configured to sample the analog data into the image 430 with almost any width 440 and any height 450. The present invention achieves most of its effective compression by sub-sampling the data image with the width 440 value less than the conventional 640 and the height 450 value less than the convention 480. In a preferred embodiment of the invention, for use in a medical application with T1 Internet transmission bandwidth, image dimensions are sub-sampled at 320 by 240.

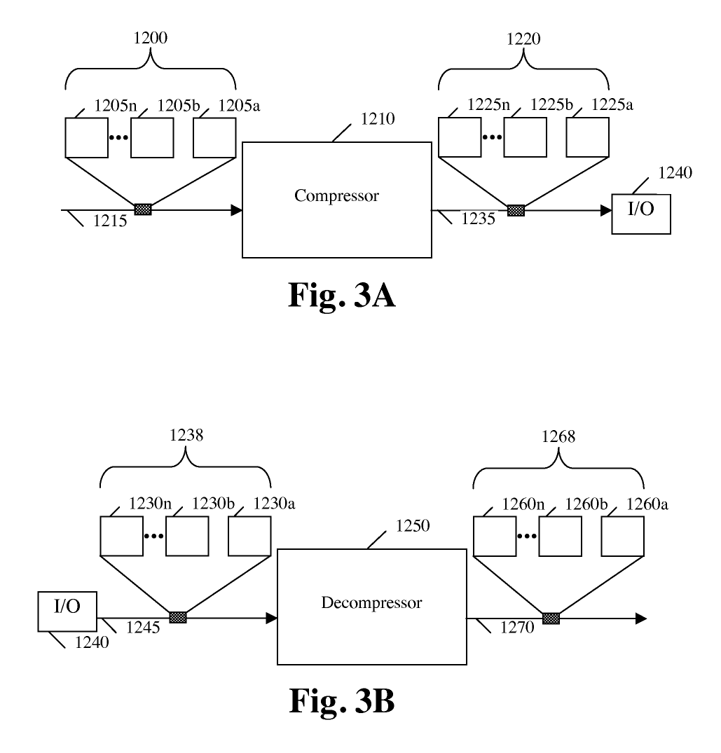

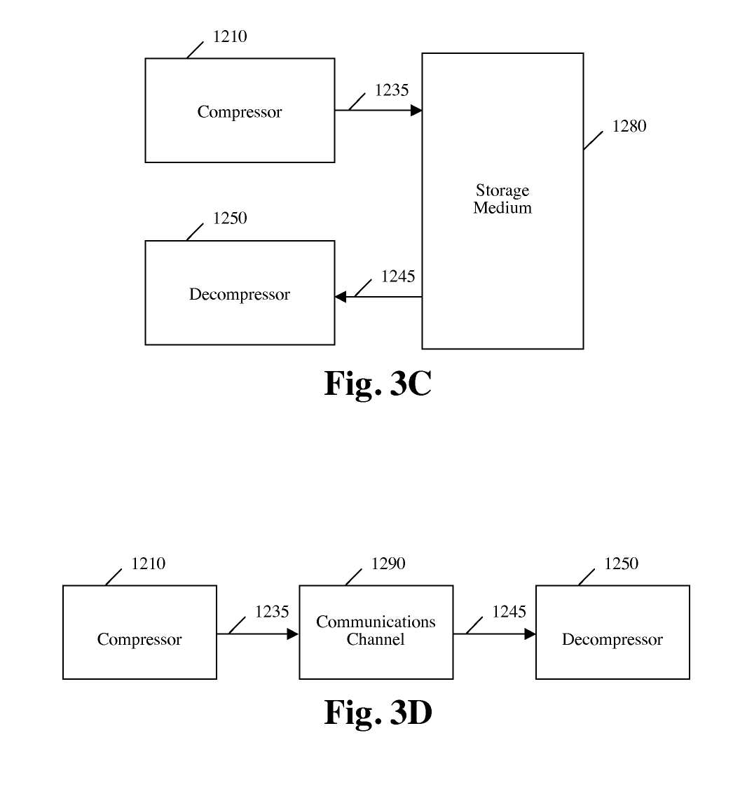

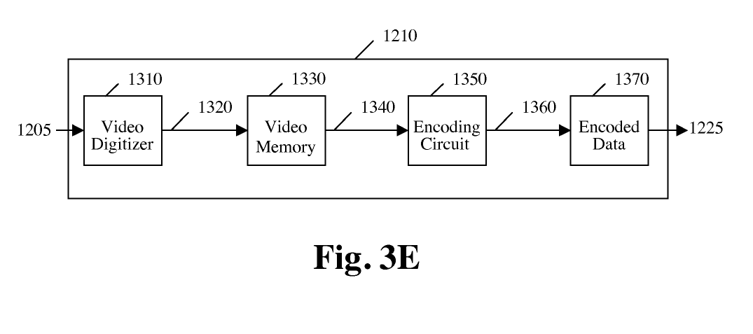

### FIGS. 3A through 3D

### Compression and Decompression Devices

FIGS. 3A and 3B show devices for compressing and decompressing, respectively, a stream of video frames.

FIG. 3A shows a video signal 1215 being compressed and encoded by a compressor 1210 to form an encoded data stream 1235, which is sent to an I/O device 1240. The video signal 1215 comprises a series of video frames 1200, shown as first video frame 1205a, second video frame 1205b, . . . through nth video frame 1205n. The encoded data stream 1235 comprises a series of encoded data 1220, shown as first encoded data 1225a, second encoded data 1225b, . . . , through nth encoded data 1225n.

FIG. 3B shows an input encoded data stream 1245 being received from an I/O device 1240, and then, decoded and decompressed by a decompressor 1250 to form a video sequence 1270. The input encoded data stream 1245 comprises received encoded data 1238, shown as first received encoded data 1230a, second received encoded data 1230b, . . . , through nth received encoded data 1230n. The video sequence 1270 comprises a series of decoded video frames 1268, shown as first decoded video frame 1260a, second decoded video frame 1260b, . . . , through nth decoded video frame 1260n.

FIG. 3C shows an embodiment where the I/O device 1240 of FIGS. 3A and 3B is a storage medium 1280. The encoded data stream 1235 from the compressor 1210 is stored in the storage medium 1280. The storage medium 1280 provides the input encoded data stream 1245 as input to the decompressor 1250.

FIG. 3D shows an embodiment where the I/O device 1240 of FIGS. 3A and 3B is a communications channel 1290. The encoded data stream 1235 from the compressor 1210 is transmitted over the communications channel 1290. The communications channel 1290 provides the input encoded data stream 1245 as input to the decompressor 1250.

### FIG. 3E

### Compressor Details

FIG. 3E shows details of an embodiment of the compressor 1210, which comprises a video digitizer 1310, a video memory 1330, an encoding circuit 1350, and encoded data 1370. Each video frame 1205 in the series of video frames 1200 is digitized by the video digitizer 1310 and stored along path 1320 in the video memory 1330. The encoding circuit 1350 access the digitized video frame via path 1340 and outputs the encoded data 1370 along path 1360. The encoded data 1225 corresponding to each video frame 1205 is then output from the compressor 1210.

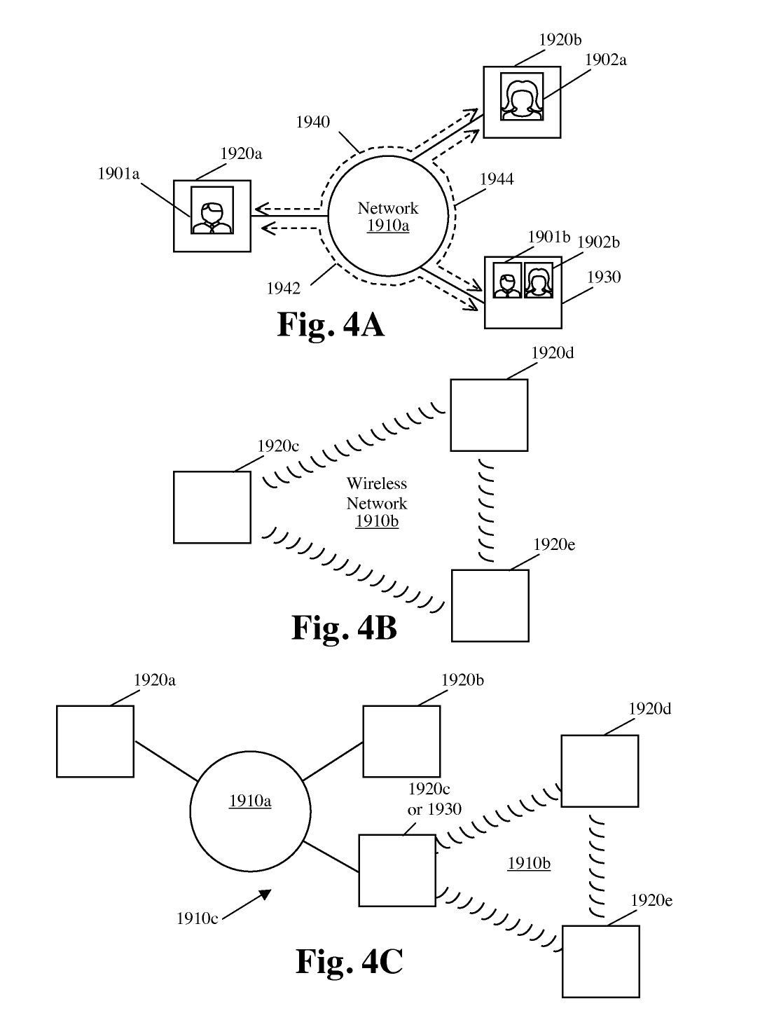

### FIGS. 4A through 4C

### Handheld Video Transmission Networks

FIGS. 4A through 4C show various network configuration comprising handheld video devices.

FIG. 4A illustrates an exemplary network 1910 comprising a first node 1920a, a second node 1920b, and an optional reflector 1930. The network 1910 is shown as a wired network 1910a. The first node 1920a is displaying a first video 1901a of a man. The second node 1920b is displaying a second video 1902a of a woman. This illustrates a videoconference between the man at the second node 1920b and the woman at the first node 1920a. In the first mode of operation, the respective videos are transmitted over a point-to-point transmission 1940 path between the two nodes over the network 1910. In another mode of operation each of the videos is transmitted to the reflector where both videos are displayed as first reflected video 1901b and second reflected video 1902b. The second video 1902a originates at the first node 1920a is transmitted to the reflector over first indirect path 1942. The second video 1901a originates at the second node 1920b is transmitted to the reflector over second indirect path 1944. The reflector then retransmits the two videos to the respective display nodes, 1920a and 1920b, over the indirect paths. In other configurations, the reflector would also transmit the combined video to other nodes participating in the videoconference.

FIG. 4B shows an example of three nodes, third node 1920c, fourth node 1920d, and fifth node 1920e in a wireless network. The wireless connections are shown as waves. The three nodes operate in the same manner as the three nodes in FIG. 4A. A well known example of a wireless local area network (LAN) is Wi-Fi (based on the IEEE 802.11 standard).

FIG. 4C shows an example of a combined network 1910c where five nodes are connect in a network comprised of both a wired network 1910a and a wireless network 1910b. Any of the five nodes could transmit video to any of the other nodes in the combined network. Any node, for example third node 1920c as shown, could act as a reflector 1930.

In another embodiment of the present invention, any node could act as a video server and transmit pre-recorded video to one or more other nodes.

These illustrations are exemplary. In practice, combined networks could consist of any number of nodes. Any of the nodes in the network could be a handheld video device.

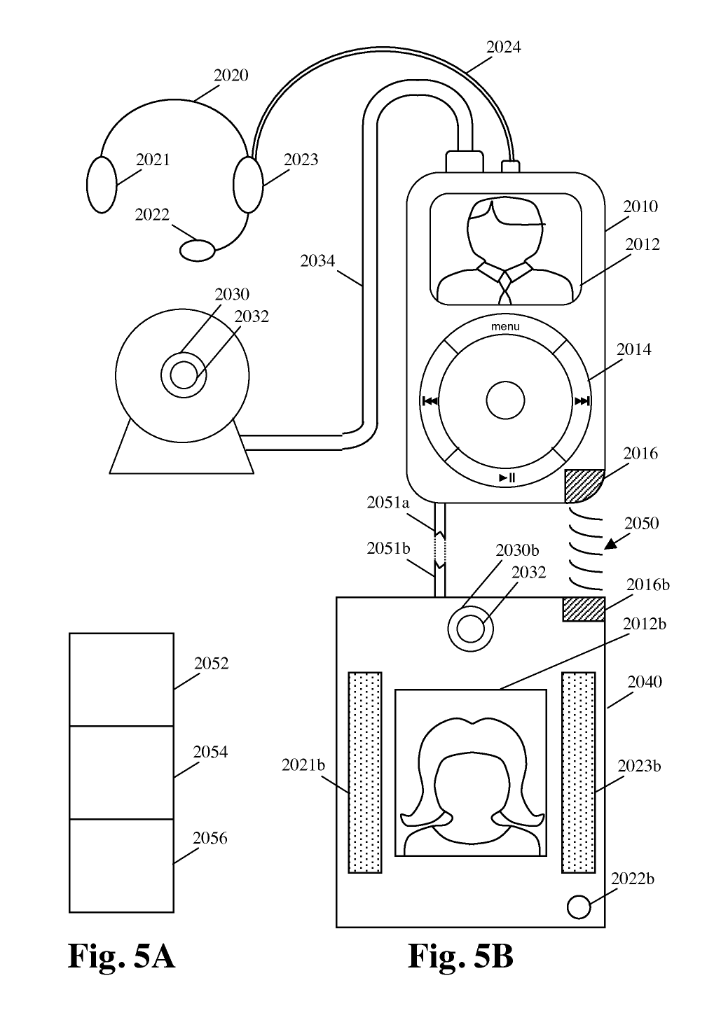

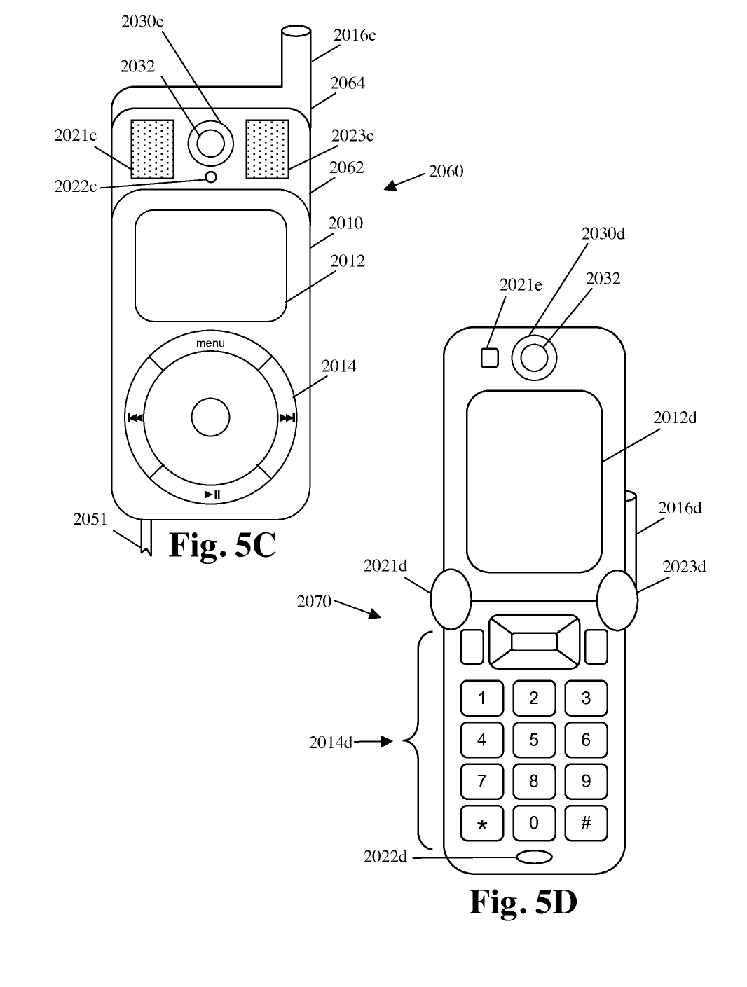

### FIGS. 5A through 5D

### Handheld Video Devices

FIGS. 5A through 5D show various embodiments of handheld video devices.

FIG. 5A shows a handheld video transmitter comprising a video source 2052, a video transmitter 2054, and video storage 2056.

FIG. 5B shows two handheld video devices in communication over either a wireless connection 2050 or a wired connection 2051.

A first handheld device 2010 comprises a display 2012, manual controls 2014, a wireless port 2016, and a first wired connection 2051a. While either the wireless port 2016 or the wired connection 2051a could be present, only one of the two would be necessary to receive video from or transmit video to other nodes in the network 1910. In this example, the first handheld device is shown as an iPod-type device with an internal hard disk drive. The first handheld device 2010 further comprises a headphone 2020, connected via a speaker/microphone cable 2024, and a camera 2030, connected via a camera cable 2034. The headphone 2020 comprises a right speaker 2021, a microphone 2022, and a left speaker 2023. The camera 2030 has a lens 2032 and internal circuitry that converts the light that passes through the lens 2032 into digital video data.

In the best mode for this embodiment, the iPod-type device is implemented using a standard Apple iPod (enhanced with an audio input for the microphone and, optionally, with a wireless port, and appropriate software), and the camera 2030 is implemented using an iBot Firewire camera manufactured by Orange Micro, a lower performing Connectix USB camera, or similar camera. Alternatively, if the iPod-type device were only used of viewing video, the Apple iPod could be used without hardware modification. In another variation, the microphone could be build into the camera (not shown) instead of the headphones.

A second handheld device 2040 comprises a second display 2012b, a second wireless port 2016b, and a second wired connection 2051b. While either the wireless port 2016b or the wired connection 2051b could be present, only one of the two would be necessary to receive video from or transmit video to other nodes in the network 1910. In this example, the second handheld device is shown as a device with a touch screen. The second handheld device 2040 further comprises a right built-in speaker 2021b, a built-in microphone 2022b, a left built-in speaker 2023b, and a built-in camera 2030b with lens 2032.

The configuration of the second handheld device 2040 has the advantage of eliminating the cables for the external headphone and camera of the first handheld device 2010 by having all elements built-in.

These two devices are exemplary. A two-device handheld videoconferencing network could have two identical handheld devices, such as the first handheld device 2010. Further, a single device with a camera (as shown) could transmit video for display on any number of hand held devices that do not have cameras or microphones.

FIG. 5C illustrates an integrated handheld device 2060 comprising an iPod type device 2010, an A/V module 2062 and an optional wireless module 2064. The iPod type device 2010 comprises display 2012, controls 2014, and a wired connection 2051. The A/V module 2062 comprises a right integrated speaker 2021c, an integrated microphone 2022c, a left integrated speaker 2023c, and an integrated camera 2030c with lens 2032. The A/V module 2062 could be manufactured and marketed separately (as shown) as an add-on module for standard iPods, or could be incorporated into the iPod packaging (or housing) as an enhanced iPod-type device. The wireless module 2064 comprises an integrated wireless port 2016c. The wireless module 2064 also could be manufactured and marketed separately (as shown) as an add-on module for standard iPods, or could be incorporated into the iPod packaging as an enhanced iPod-type device.

The configuration of the integrated handheld device 2060 has the advantage of eliminating the cables for the external headphone and camera of the first handheld device 2010 by having all elements integrated into removably attached modules that form a single unit when attached. The user can configure the standard iPod based on the user's intended use. If only a wireless connection is needed, only the wireless module 2064 can be attached to the iPod; in this configuration video can be received and displayed but not transmitted. If only video transmission is necessary and a wired connection is convenient, the wireless module 2064 can be omitted. Either configuration provides a single integrated unit that can be carried in the user's pocket and can store and display videos.

FIG. 5D illustrates an cellular integrated device 2070 comprising phone display 2012d, phone controls 2014d (including a number keypad), a cellular port 2016d, a right phone speaker 2021d, a phone earphone 2021e, phone microphone 2022d, left phone speaker 2023d, and a phone camera 2030d with lens 2032.

Any of the handheld devices shown in FIGS. 5A through 5D could be nodes in video transmission networks, such as those shown in FIGS. 3D and 4A through 4C. Each transmitting device preferably would include a compressor 1210 as shown in FIGS. 3A and 3D. Each receiving device preferably would include a decompressor 1250 as shown in FIGS. 3B and 3D. The compressor 1210 and decompressor 1250 preferably would implement one or more embodiments of the compression methods discussed above.

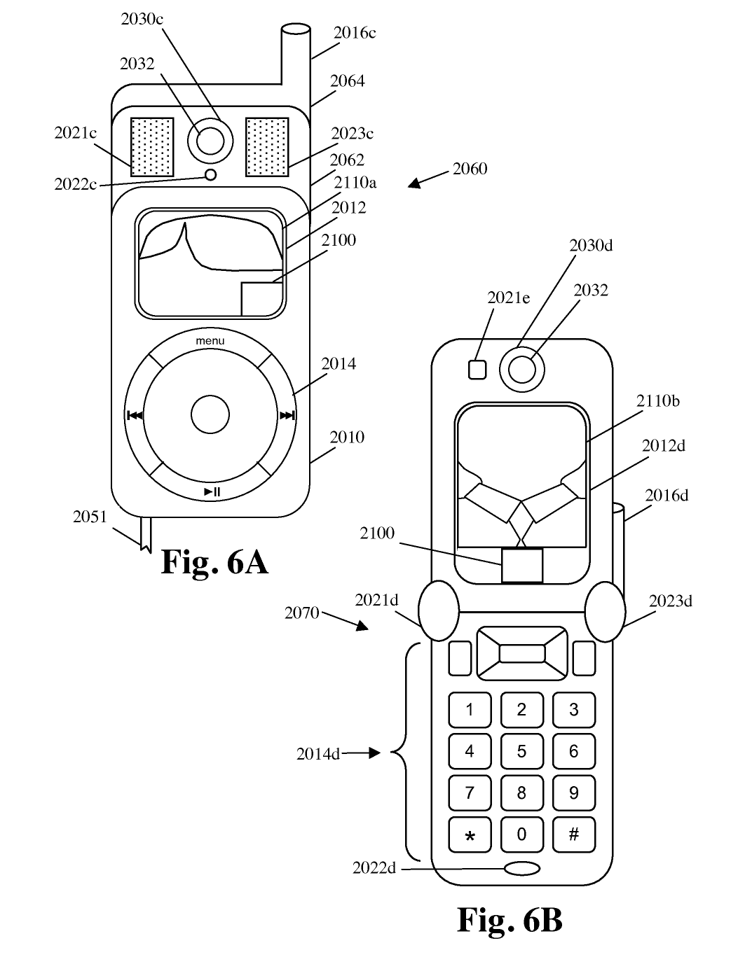

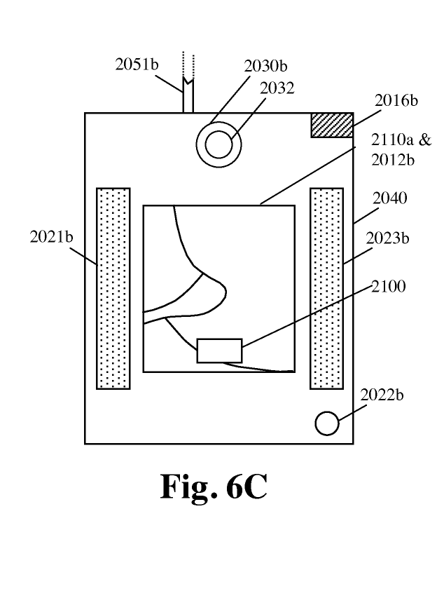

### FIGS. 6A through 6C

### Handheld Video Devices with Graphical Zoom Control

FIGS. 6A through 6C show exemplary handheld video devices comprising graphical zoom controls.

A graphical user interface (GUI) graphically corresponds to a video display window 2110 through which a single image or a stream of video frames is displayed. The GUI and the video display window 2110 are displayed on a display 2012 (or 2012b or 2012d). The GUI includes a zoom control 2100. The zoom control 2100 is a graphical way for the user to control the area of the video to be compressed and transmitted.

FIG. 6A shows an embodiment of the iPod-type handheld device 2010 of FIG. 5C displaying a zoom control 2100. The zoomed video image is shown in video display window 2110a. In this embodiment, the zoom control 2100 is displayed on top of the video display window 2110a.

FIG. 6B shows an embodiment of the cellular integrated device 2070 of FIG. 5D displaying a zoom control 2100. The zoomed video image is shown in alternate video display window 2110b. In this embodiment, the zoom control 2100 is displayed outside and below the alternate video display window 2110b.

FIG. 6C shows an embodiment of the second handheld device 2040 of FIG. 5B displaying a zoom control 2100. The zoomed video image is shown in a video display window 2110a shown filling the second display 2112b. In this embodiment, the zoom control 2100 is displayed over the video display window 2110a. In this embodiment, the controls (similar in function to controls 2014) are incorporated into a touch screen of the second display 2012b. The user enters zoom in, zoom out, and pan commands.

### Operation of Graphical Zoom Controls

A user controls aspects and changes parameters of the image displayed within the video display window 2110 using the controls 2014 to enter input commands within the zoom control 2100 by selecting appropriate parts of the controls 2104 (or regions of the zoom control 2100 on a touch screen or with a pointing device). The controls 2014 can be a touch screen, touch pad, iPod-like scroll pad, remote control or other device, depending on the configuration of the handheld device.

The display 2012 including the video display window 2110 and a graphical user interface including the zoom control 2100.

The magnification factor 104 is changed by using the touch screen or controls 2014 (or 2014d) to zoom in or zoom out.

A user zooms out on a specific portion of the image to decrease the magnification factor 104.

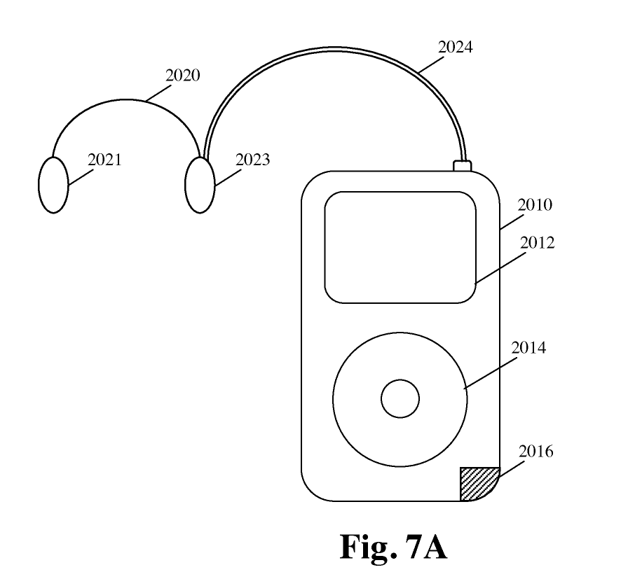

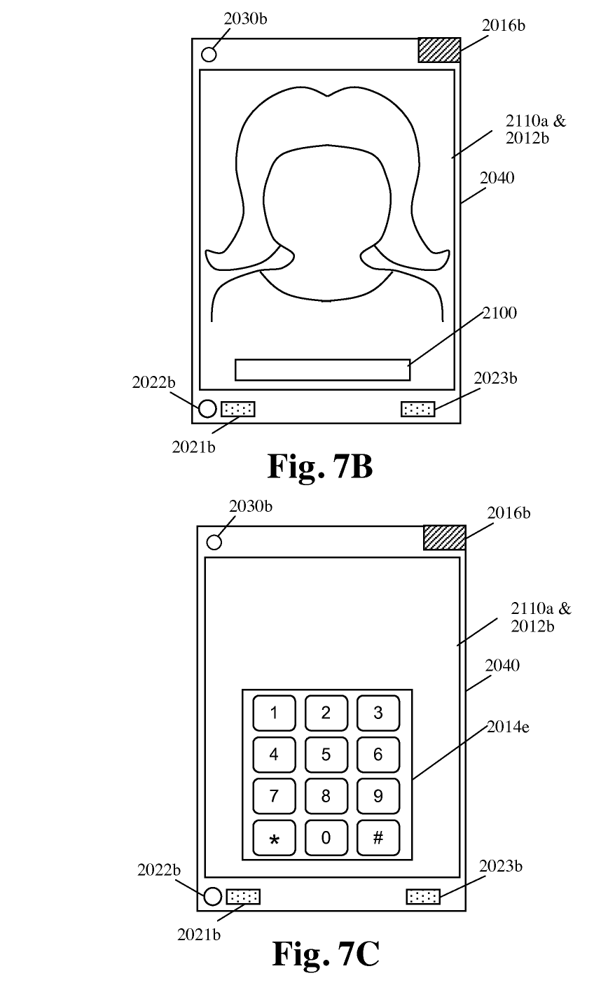

### FIGS. 7A through 7C

### Handheld Wireless Digital Audio and Video Devices

FIGS. 7A through 7C show exemplary handheld wireless digital audio and video devices.

FIG. 7A shows an embodiment of the iPod-type handheld device 2010 comprising a display 2012, manual controls 2014, a wireless port 2016. The handheld device 2010 further comprises a headphone 2020, connected via a speaker/microphone cable 2024. The headphone 2020 comprises a right speaker 2021 and a left speaker 2023. In one embodiment the wireless port 2016 is configured to receive audio data wirelessly from a satellite network or from an Internet data network.

FIG. 7B shows an embodiment of handheld wireless digital video device displaying a zoom control 2100. The device comprises a second display 2012b that is a touch screen display, a second wireless port 2016b, a right built-in speaker 2021b, a built-in microphone 2022b, a left built-in speaker 2023b, and a built-in camera 2030b. The zoomed video image is shown in alternate video display window 2110b. In this embodiment, the zoom control 2100 is displayed outside and below the alternate video display window 2110b. The second wireless port 2016b is configured to connect to a wireless Internet data network. The camera 2030b on the front of the device allows for video to be captured and displayed on the touch screen display, and at the same time the video stream may be transmitted as part of a video conference as discussed above.

FIG. 7C shows the handheld wireless digital video device of FIG. 7B displaying a touch screen phone control 2014e. In this embodiment the phone controls are incorporated into a touch screen of the second display 2012b. The a second wireless port 2016b is also configured to connect to a cellular network and allows the device to function as a cellular telephone, and to received digital video data over the cellular network when the Internet data network is not available.

### Advantages

### Video Coverage of Remote Events

The handheld wireless video transmitters allow for low cost, portable, video transmission of events of interest whenever and wherever they happen. These handheld wireless video transmitters will be able to provide news coverage of wars, natural disasters, terrorist attacks, traffic and criminal activities in a way that has never before been possible.

### Improved Continuous Communication

The handheld wireless media devices enable enhanced personal communication between friends, family, and co-workers in ways never before possible.

### Improved Entertainment and Education

The handheld wireless media devices enable the transmission of video-based entertainment and education in ways never before possible. User will be able to use pocket-sized, handheld device to watch video that are downloaded from a global media exchange, streamed from a video server, or transmitted live from a performance, classroom, laboratory, or field experience.

### Improved Healthcare

The present invention would enable a physician or medical specialist to receive medical quality video any time in any location. For example, a critical emergency room ultrasound study could be monitored while it is being performed by less skilled emergency room personnel ensuring that the best medical image is acquired. A rapid diagnosis can be made and the results of a study can be verbally dictated for immediate transcription and use within the hospital.

Further, the present invention could be used to transmit medical quality video from a remote, rural location, including a battleground. It could also be used to transmit guidance and advice from an expert physician into a remote, rural location.

Thus, the present invention can improve medical care, reduce the turnaround for analysis of medical studies, reduce the turnaround for surgery, and provide medical professionals with continuous access to medical quality imaging.

### CONCLUSION, RAMIFICATION, AND SCOPE

Accordingly, the reader will see that handheld wireless devices are used to receive and display high quality video or play digital audio. The video can be displayed as it is received live and a graphical zoom control can be used to dynamically control the area of the source image that is to be transmitted in full resolution. In other embodiments, a handheld wireless device captures the video with a video camera and microphone and the device transmits the video images live as they are captured. A single handheld wireless video transmitter can transmit to multiple handheld wireless receivers. A plurality of handheld wireless video devices which capture, transmit, receive, and display video over a network are used for mobile video conferencing. In other embodiments the video data is transferred as a video file or streamed from a video server contain pre-recorded video files.

Further the compression and decompression provides a means of digitally compressing a video signal in real time, communicating the encoded data stream over a transmission channel, and decoding each frame and displaying the decompressed video frames in real time.

Furthermore, the present invention has additional advantages in that it:
1. enables live video transmission and display on pocket-sized handheld devices;
2. enables wireless videoconferencing with portable, handheld video devices;
3. provides an iPod-type device which is able to display high quality color video;
4. provides an iPod-type device which is able to be used as a wireless video transmitter or receiver;
5. provides an iPod-type device which is able to be used as a wireless Internet audio receiver;
6. enables video coverage of remote events or catastrophic events;
7. improves interpersonal communication, productivity, and effectiveness;
8. improves education;
9. improves entertainment;
10. improves and expands healthcare at lower costs;
11. provides a means for reducing the space required in a storage medium.

Although the descriptions above contain many specifics, these should not be construed as limiting the scope of the invention but as merely providing illustrations of some of the preferred embodiments of this invention. For example, the physical layout, cable type, connectors, packaging, and location of the video display or video camera can all be altered without affecting the basic elements of the claimed embodiments. Further, bit ordering can be altered and the same relative operation, relative performance, and relative perceived image quality will result. Also, these processes can each be implemented as a hardware apparatus that will improve the performance significantly.

Thus the scope of the invention should be determined by the appended claims and their legal equivalents, and not solely by the examples given.

I claim:

1. A handheld wireless digital media device, comprising:
a) a processor for executing a plurality of instructions comprising one or more programs,
b) a program memory for storing the one or more programs, connected to the processor,
c) a media memory for storing a multiplicity of digital media, the digital media comprising compressed digital audio or compressed digital video data, the media memory connected to the processor,
d) a wireless port for connecting to a wireless network to receive the multiplicity of digital media, the wireless port connected to the processor,
e) a display, the display connected to the processor,
f) a plurality of user inputs, the user inputs connected to the processor,
g) a microphone, connected to the processor,
h) at least one speaker, connected to the processor,
i) a camera, connected to the processor, and
j) a headphone connection, configured to receive a head phone,
wherein the handheld wireless digital media device has a front and a back,
wherein the handheld wireless digital media device is configured with a predetermined device height, a predetermined device height, and a predetermined device depth,
wherein the device height is less than about four and one half inches,
wherein the device width is less than about two and one half inches,
wherein the device depth is less than about one half inch,
wherein the handheld wireless digital media device is configured with a predetermined device weight,
wherein the device weight is less than about six ounces,
wherein the display is a high-resolution color graphical display, having a display height and a display width, the display height and the display width measured in pixels,
wherein the display height at least 480,
wherein the display width at least 640,
wherein at least one of the user inputs is a touch screen incorporated into the display,
wherein the user inputs comprise phone controls,
wherein the phone controls are selectively displayed on the touch screen,
wherein the camera is configured to capture high resolution digital video,
wherein the display is positioned on the front of the device,
wherein the camera is positioned on the front of the device,
wherein the user inputs comprise video controls,
wherein the video controls including video playback controls,
wherein the video controls including camera controls,
wherein at least one captured video stream is compressed,
[wherein the compressed captured video stream is stored in the media memory,]
wherein the wireless port is configured to connected to an Internet data network,
wherein the wireless port is configured to connected to cellular phone network,
wherein the wireless port is configured to transmit the at least one captured video stream,
wherein the compressed captured video stream is transmitted over the wireless port,
wherein one of the multiplicity of digital media is a video stream being received over the wireless port at the same time that the compressed captured video stream being transmitted, and
wherein the headphone connection is configured to output stereo audio and to input audio.

2. A handheld wireless digital media device, comprising:
a) a processor for executing a plurality of instructions comprising one or more programs,
b) a program memory for storing the one or more programs, connected to the processor,
c) a media memory for storing a multiplicity of digital media, the digital media comprising compressed digital audio or compressed digital video data, the media memory connected to the processor,
d) a wireless port for connecting to a wireless network to receive the multiplicity of digital media, the wireless port connected to the processor,
e) a display, the display connected to the processor,
f) a plurality of user inputs, the user inputs connected to the processor,
g) a microphone, connected to the processor,
h) at least one speaker, connected to the processor, and
i) a headphone connection, configured to receive a head phone.

3. The device of claim 2, further comprising a camera, connected to the processor.

4. The device of claim 3, wherein the camera is configured to capture high-resolution digital video.

5. The device of claim 3, wherein the handheld wireless digital media device has a front and a back,
wherein the display is positioned on the front of the device, and
wherein the camera is positioned on the back of the device.

6. The device of claim 3, wherein the handheld wireless digital media device has a front and a back,
wherein the display is positioned on the front of the device, and
wherein the camera is positioned on the front of the device.

7. The device of claim 2, wherein the handheld wireless digital media device is configured with a predetermined device height, a predetermined device height, and a predetermined device depth,
wherein the device height is less than about four and one half inches,
wherein the device width is less than about two and one half inches, and
wherein the device depth is less than about one half inch.

8. The device of claim 2, wherein the handheld wireless digital media device is configured with a predetermined device weight,
wherein the device weight is less than about six ounces.

9. The device of claim 2, wherein the display is a high-resolution color graphical display, having a display height and a display width, the display height and the display width measured in pixels,
wherein the display height at least 480, and
wherein the display width at least 640.

10. The device of claim 2, wherein at least one of the user inputs is a touch screen incorporated into the display.

11. The device of claim 2 wherein the user inputs comprise phone controls.

12. The device of claim 11 wherein the phone controls are selectively displayed on the touch screen.

13. The device of claim 2 wherein the user inputs comprise video controls.

14. The device of claim 13 wherein the video controls including video playback controls.

15. The device of claim 4 wherein at least one captured video stream is compressed.

16. The device of claim 15 wherein the compressed captured video stream is stored in the media memory.

17. The device of claim 2 wherein the wireless port is configured to connected to an Internet data network.

18. The device of claim 2 wherein the wireless port is configured to connected to cellular phone network.

19. The device of claim 15 wherein the wireless port is configured to transmit the at least one captured video stream, and
wherein the compressed captured video stream is transmitted over the wireless port.

20. The device of claim 19 wherein the wireless port is configured to transmit the at least one captured video stream, and
wherein one of the multiplicity of digital media is a video stream being received over the wireless port at the same time that the compressed captured video stream being transmitted, and

21. The device of claim 2 wherein the headphone connection is configured to output stereo audio and to input audio.

22. A handheld wireless digital media device, comprising:
a) a processor for executing a plurality of instructions comprising one or more programs,
b) a program memory for storing the one or more programs, connected to the processor,
c) a media memory for storing a multiplicity of digital media, the digital media comprising compressed digital audio data, the media memory connected to the processor,
d) a wireless port for connecting to a wireless network to receive the multiplicity of digital media, the wireless port connected to the processor,
e) a display, the display connected to the processor,
f) a plurality of user inputs, the user inputs connected to the processor, and
g) a headphone connection, configured to receive a head phone,
wherein the handheld wireless digital media device is configured with a predetermined device height, a predetermined device height, and a predetermined device depth,
wherein the device height is less than about four and one half inches,
wherein the device width is less than about two and one half inches,
wherein the device depth is less than about one half inch,
wherein the handheld wireless digital media device is configured with a predetermined device weight,
wherein the device weight is less than about six ounces,
wherein the user inputs comprise audio controls,
wherein the audio controls include audio playback controls,
wherein the wireless port is configured to connected to an Internet data network,
wherein the wireless port is configured to connected to satellite network, and
wherein the headphone connection is configured to output stereo audio.
